(19) United States
(12) Patent Application Publication
(10) Pub. No.: US 2001/0016115 A1
(43) Pub. Date: Aug. 23, 2001

(54) Panel heater

(76) Inventors: Akisuke Hirata, Fujisawa-shi (JP); Masami Ohtugu, Nagano-ken (JP)

Correspondence Address: ARENT FOX KINTNER PLOTKIN & KAHN, PLLC, Suite 600, 1050 Connecticut Avenue, N.W., Washington, DC, 20036-5339, US

(21) Appl. No.: 09/773,014

(22) Filed: Jan. 31, 2001

(30) Foreign Application Priority Data
Feb. 1, 2000 (JP) 23712/2000

(51) Int. Cl. H05B 3/20; H05B 3/30

(52) U.S. Cl. 392/435; 219/544; 338/311

(57) ABSTRACT

A panel heater is made of a metallic panel member and an ohmic heat generating body which is covered with a sheath member and which is embedded in the metallic panel member. One of the sheath member and the panel member is formed by a first material capable of being alloyed with, and having a coefficient of thermal expansion close to a coefficient of thermal expansion of, a second material for the other of the sheath member and the panel member. The sheath member and the panel member are seamlessly integrated by diffusion bonding at a high temperature and high pressure.

### BACKGROUND OF THE INVENTION

1. Field of the Invention

The present invention relates to a panel heater which generates heat by ohmic-resistance heating and which is applied as a general-purpose heater or a heater for an apparatus for manufacturing a liquid crystal display panel with thin film transistor (TFT) arrays, an apparatus for manufacturing a semiconductor device such as a silicon wafer or the like.

2. Description of Related Art

Conventionally, as a panel heater, there has been known one as shown in FIGS. 6 through 8. Namely, an ohmic heat generating body “a” is covered by a sheath member c through an insulating body b such as magnesium oxide to thereby obtain a heat generating body d. The heat generating body d is then embedded in a panel member e. A stainless steel tube or the like is used as the sheath member c and carbon or aluminum is used as the panel member e. However, there is a disadvantage in that the panel member made of carbon which discharges gases in a vacuum atmosphere is not easy to be fabricated. Therefore, aluminum is normally used as the panel member. In manufacturing the panel heater, the following method is employed. Namely, the sheath member c is disposed inside a mold, and molten aluminum is poured into the mold.

In a panel heater having a heat generating body of a sheath structure, electric power is much charged in order to improve capability such as temperature elevating speed or the like. However, electric power which can be charged (allowable power density) is restricted by high temperature durability of an ohmic heat generating body itself or a sheath member, and by heat transfer rate between the sheath member and a panel member. Accordingly, when the heat resistance and the heat transfer rate are not excellent, a panel heater with a high performance cannot be obtained.

In order to reduce an influence of a size difference between the sheath member and the panel member occurring due to a difference in temperature between both the members or an influence of a difference in coefficient of thermal expansion therebetween, a slight clearance is secured between both the members, thereby allowing sliding between these members. This clearance deteriorates the thermal transfer rate. If the clearance is canceled to give a priority to the thermal transfer rate, there occurs a disadvantage in that the sheath member is damaged or strain is induced in the panel member due to mechanical stresses caused by the size difference at the time of thermal expansion.

Furthermore, since the panel heater has many applications, it is subjected to many chemical, metallurgical and thermal restrictions or the like regarding kinds of material to be used as the panel member due to an environment in which the panel heater is installed. Even if kind of material which meets these restrictions is selected and a panel member is manufactured using this kind of material, a sheath member suitable for the coefficient of linear thermal expansion of the panel member is often inferior in heat resistance or heat conductivity required as the material for a heater. As a result, a panel heater with a high efficiency cannot be obtained.

As a method of embedding a heat generating body of a sheath structure into a panel member, there has been practiced, aside from the above-described casting method, a mechanical bonding method in which a heat generating body is sandwiched between two sheets of panel members or it is caulked therebetween. However, in both the above-described methods, the difference in thermal expansion between the sheath member and the panel member is taken for granted or is left as it is, and sliding or deformation between both the members in the bonded state is taken into account or anticipated. For this reason, a panel heater with excellent heat transfer rate and flatness cannot be obtained.

In view of the above points, the present invention has an object of providing a panel heater which utilizes ohmic heating and has excellent heat transfer rate, high temperature durability and which is reduced in thermal distortion due to age deterioration.

### SUMMARY OF THE INVENTION

In order to attain the above and other objects, according to the present invention, there is provided a panel heater comprising: a metallic panel member; an ohmic heat generating body which is covered with a sheath member and which is embedded in the metallic panel member, wherein one of the sheath member and the panel member is formed by a first material capable of being alloyed with, and having a coefficient of thermal expansion close to a coefficient of thermal expansion of, a second material for the other of the sheath member and the panel member, and wherein the sheath member and the panel member are seamlessly integrated by diffusion bonding at a high temperature and high pressure.

Preferably, the sheath member has a thin thickness structure. The panel member is made of an aluminum base composite material which is made by mixing a reinforcing material in aluminum, and the sheath member is made of an aluminum alloy. The reinforcing material is at least one of carbon fiber, alumina fiber, silicon carbide fiber, alumina particle and silicon particle. The diffusion bonding is made by one of hot isostatic pressing, hot pressing, and hot forging.

According to another aspect of the present invention, there is provided a panel heater comprising: a metallic panel member; an ohmic heat generating body which is covered with a sheath member and which is embedded in the metallic panel member, wherein the sheath member is formed into a two-layer construction having an inner layer and an outer layer, the outer layer being made of an alloy suitable for brazing and having a melting point which is lower than a melting point of the inner layer, and wherein the sheath member and the panel member are seamlessly integrated by brazing.

According to the present invention, one of the sheath member and the panel member is formed by a first material capable of being alloyed with, and having a coefficient of thermal expansion close to a coefficient of thermal expansion of, a second material for the other of the sheath member and the panel member, and the sheath member and the panel member are seamlesslly integrated by diffusion bonding at a high temperature and high pressure. Therefore, thermal transfer rate is improved and, consequently, a high temperature can be obtained at a radiation surface of the panel heater. Also, since thermal distortion occurs in neither of the sheath member and the panel member, damages to the sheath member and strain of the panel member are prevented. As a result, a long life of the panel heater can be attained. Simultaneously, temperature ascent/descent response is improved at a time of temperature adjustment.

Furthermore, since the thermal distortion is small, the panel heater can be large-scaled, so that the present invention can advantageously be applied to a chemical vapor deposition (CVD) apparatus for manufacturing a large-area TFT or to a similar apparatus.

### BRIEF DESCRIPTION OF THE DRAWINGS

The above and other objects and the attendant advantages of the present invention will become readily apparent by reference to the following detailed description when considered in conjunction with the accompanying drawings wherein:

FIG. 1 is a perspective view of an embodiment of the present invention;

FIG. 2 is an enlarged perspective view of an ohmic heat generating body in FIG. 1;

FIG. 3 is an enlarged view of a main portion in FIG. 2;

FIG. 4 is a perspective view showing another embodiment of the present invention;

FIG. 5 is an enlarged sectional view of a main portion in FIG. 4;

FIG. 6 is a front view of a conventional panel heater;

FIG. 7 is a side view, partly shown in section, of the panel heater in FIG. 6; and

FIG. 8 is an enlarged sectional view of a main portion in FIG. 7.

### DETAILED DESCRIPTION OF PREFERRED EMBODIMENTS

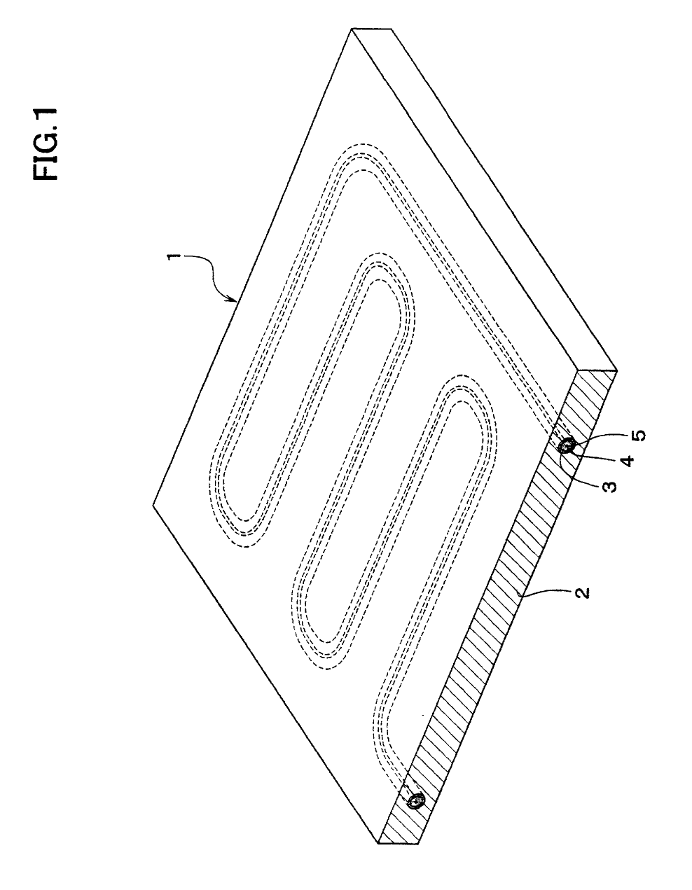

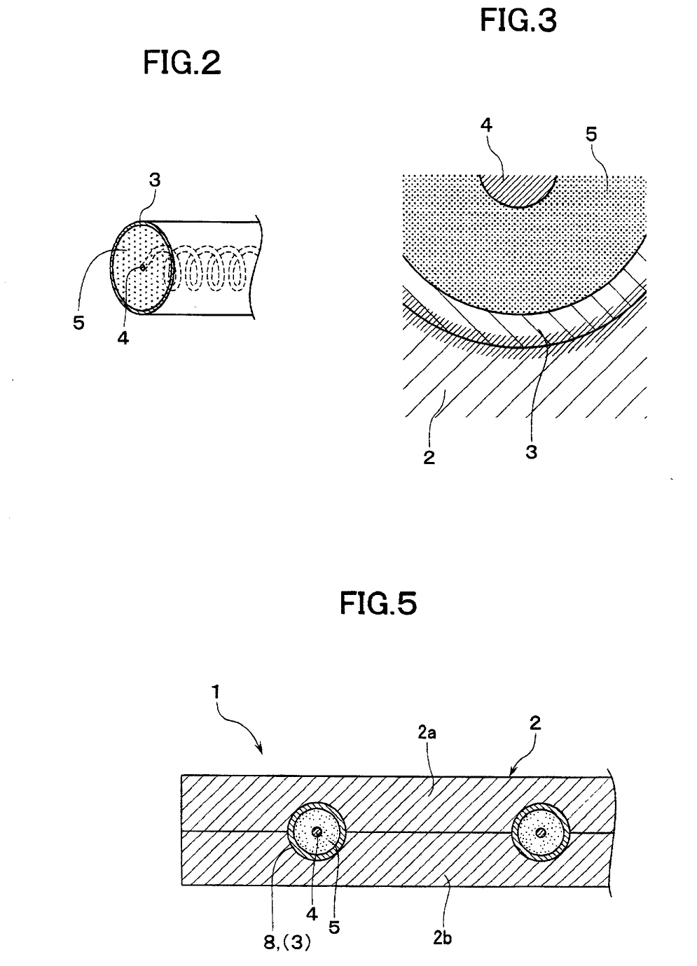

Embodiments of the present invention will be explained with reference to the drawings. In FIG. 1, reference numeral 1 denotes a panel heater in which an ohmic heat generating body 4 covered with a sheath member 3 is embedded in a panel member 2. An enlarged view of the ohmic heat generating body 4 is shown in FIG. 2. The ohmic heat generating body 4 is made of an electrically conductive body which is a spiral wire such as a Nichrome wire, an iron chrome wire or the like and which generates ohmic heat. The ohmic heat generating body 4 is covered with an electrically insulating body 5 such as magnesium oxide and an outer periphery of the insulating body 5 is covered with a metallic sheath member 3. As materials for the panel member 2 and for the sheath member 3, there may be selected ones having coefficients of thermal expansion which are close to each other so as to alloy both the members through diffusion. As the panel member 2, there may be used metal such as aluminum, its alloy (the chemical composition limits are as defined by Japanese Industrial Standards, JIS A1050, A6061, A5052 or the like), pure Cu, Monel alloy (Ni—Cu) or the like. The major alloying elements of the above-described alloys are as follows. Alloy JIS A1050 contains 99.50 weight % or more of aluminum (Al). Alloy JIS A6061 contains (in weight %): 0.8-1.2% of Mg; 0.40-0.8% of Si; 0.15-0.40% of Cu; 0.04-0.35% of Cr; the remaining being aluminum (Al). Alloy JIS 5052 contains (in weight %): 2.2-2.8% of Mg; 0.15-0.35% of Cr; the remaining being aluminum (Al). When it is necessary to make the panel member 2 into a large size and to make its coefficient of thermal expansion small, there may be used, as the panel member 2, aluminum base composite material in which reinforcing material such as carbon fiber, alumina fiber, silicon carbide fiber, alumina particle, silicon carbon particle is mixed in aluminum or its alloy. As the material for the sheath member 3, there may be used metal which can be alloyed with the panel member 2 and whose coefficient of thermal expansion is close to that of the panel member 2. Such material may be selected from aluminum, its alloy (the chemical composition limits are as defined by JIS A3003, A1100, A6061, A6063 or the like), stainless steel, pure Cu, pure Ni or the like. Alloy JIS A3003 contains (in weight %): 1.0-1.5% of Mn; 0.05-0.20% of Cu; the remaining being aluminum (Al). Alloy JIS A1100 contains 99.00 weight % or more of aluminum (Al) and 0.05-0.20% of Cu. Alloy JIS A6063 contains (in weight %): 0.45-0.9% of Mg; 0.20-0.6% of Si; the remaining being aluminum (Al). The sheath member 3 is formed into a structure having a diameter of about 5 to 20 mm and a thin thickness of about 1 to 1.5 mm.

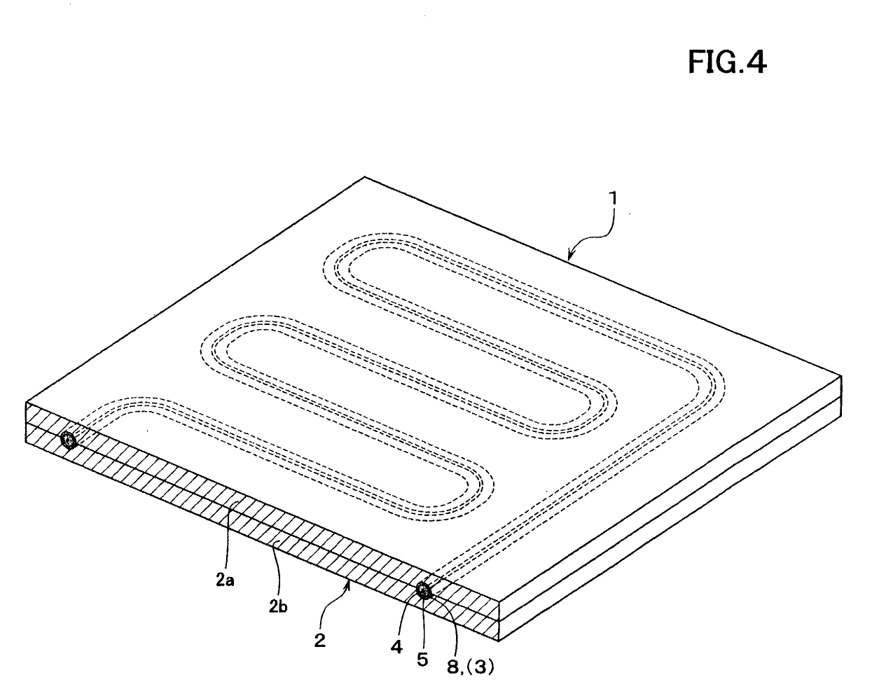

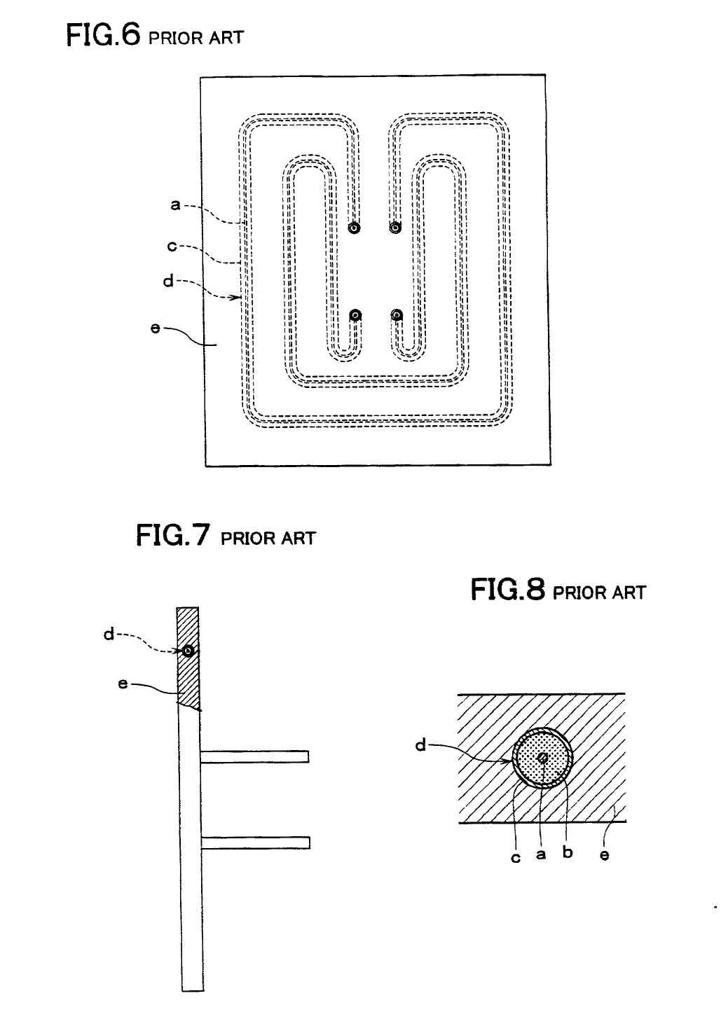

Embedding of the ohmic heat generating body 4 is achieved, as shown in FIG. 4, by the following steps. Namely, a groove is formed in one or both joining surfaces of panel members 2a, 2b which are horizontally divided into vertically disposed two pieces. The ohmic heat generating body 4 which has been covered with the sheath member 3 is disposed in the groove in a zigzag line. After the members 2a, 2b and the ohmic heat generating body 4 are assembled into a sandwiched structure, the subassembly obtained in the above-described steps is subjected to a high-temperature and high-pressure such as by HIP (hot isostatic pressing), hot pressing, hot forging or the like. By subjecting the sub-assembly to the above-described processing, joining surfaces of the panel member 2 and the sheath member 3 are diffusion-bonded (or bonded through diffusion), as shown in FIG. 3. In the figure, the shaded area in the border between the panel member 2 and the sheath member 3 shows the area thus bonded by diffusion bonding. Since the coefficients of linear thermal expansion of the panel member 2 and the sheath member 3 are equal to each other in this bonded portion, a temperature difference between both the members 2 and 3 is minimized and sliding does not occur between both the members 2 and 3. Therefore, damages to the sheath member 3 or strain of the panel member 2 due to difference in thermal expansion does not occur even at a high temperature. In addition, since there is no clearance or gap between both the members 2 and 3, thermal transfer rate was found good and calorie can efficiently be discharged from the surface of the panel member 2 in response to the charged electric power.

In case there is employed a panel member 2 made of a composite material in which the above-mentioned reinforcing material is mixed, an excellent diffusion bonding can be obtained at a high temperature and high pressure if any one of the materials as defined by JIS A3003, A1100, A6061 and A6063 is used for the sheath member 3. Further, when any one of the materials as defined by JIS A1050, A6061 and A5052 is used for the panel member 2, it is preferable to use any one of the materials as defined by JIS A3003, A1100, A6061 and A6063 as the material for the sheath member 3. When these materials are used, the high-temperature and high-pressure are preferably as follows. Namely, the hot isostatic pressing is made at 1300 atmospheres and 450° C., the hot pressing is made at 500° C. for 3 hours, and the hot forging is made at 500° C.

Further, when Monel alloy (Ni—Cu) is used as the material for the panel member 2, pure Ni is used for sheath member 3 and a high temperature of 1200° C. and a high pressure of 1300 atmospheres are applied. When SUS304/316 is used for the panel member 2, SUS 304/316 shall also be used for the sheath member 3. Furthermore, when pure Cu is used for the panel member 2, excellent diffusion bonding can be obtained by using pure Cu or pure Ni for the sheath member 3.

In case aluminum alloy which allows bonding by brazing is selected for the panel member 2, as shown in FIGS. 4 and 5, the following steps are taken. Namely, two sheets of panel members 2a and 2b are prepared. The sheath member 3 is formed by a brazing sheet 8 made of aluminum alloy and having a two-layer construction of an inner layer and an outer layer (though not illustrated as such in the figure). The ohmic heat generating body 4 is sandwiched between both the panel members 2a, 2b with an electrically insulating material 5 filled therein. Bonding by brazing is then performed at a high temperature of about 600° C. so that the panel member 2 and the sheath member 3 can be joined in diffusion bonding. In this case, when any one of the materials as defined by JIS A1050, A3003 and A6063, for example, is used for the two sheets of the panel members 2a and 2b, the brazing sheet 8 of two-layer construction is made as follows. Namely, material for a core (inner layer) is made of JIS A3003 and a skin (outer layer containing a brazing filler metal) is made of JIS A4003 or A4005. Furthermore, in this case, more excellent joining can advantageously be performed by bonding by brazing at a high temperature and a high pressure (for example, 600° C. and 1300 atmospheres).

In the above explanations, reference is made to “pure” Cu and Ni. It is to be noted, however, that this term “pure” is intended to denote a commercially available purity within a range that does not materially affect the characteristics of the present invention.

It is readily apparent that the above-described panel heater meets all of the objects mentioned above and also has the advantage of wide commercial utility. It should be understood that the specific form of the invention hereinabove described is intended to be representative only, as certain modifications within the scope of these teachings will be apparent to those skilled in the art.

Accordingly, reference should be made to the following claims in determining the full scope of the invention.

What is claimed is:

1. A panel heater comprising:
a metallic panel member;
an ohmic heat generating body which is covered with a sheath member and which is embedded in said metallic panel member,
wherein one of said sheath member and said panel member is formed by a first material capable of being alloyed with, and having a coefficient of thermal expansion close to a coefficient of thermal expansion of, a second material for the other of said sheath member and said panel member, and
wherein said sheath member and said panel member are seamlessly integrated by diffusion bonding at a high temperature and high pressure.

2. The panel heater according to claim 1, wherein said sheath member has a thin thickness structure.

3. The panel heater according to claim 1, wherein said panel member is made of an aluminum base composite material which is made by mixing a reinforcing material in aluminum, and wherein said sheath member is made of an aluminum alloy.

4. The panel heater according to claim 2, wherein said panel member is made of an aluminum base composite material which is made by mixing a reinforcing material in aluminum, and wherein said sheath member is made of an aluminum alloy.

5. The panel heater according to any one of claims 1 through 4, wherein said reinforcing material is at least one of carbon fiber, alumina fiber, silicon carbide fiber, alumina particle and silicon particle.

6. The panel heater according to any one of claims 1 through 4, wherein said diffusion bonding is made by one of hot isostatic pressing, hot pressing, and hot forging.

7. A panel heater comprising:
a metallic panel member;
an ohmic heat generating body which is covered with a sheath member and which is embedded in said metallic panel member,
wherein said sheath member is formed into a twolayer construction having an inner layer and an outer layer, said outer layer being made of an alloy suitable for brazing and having a melting point which is lower than a melting point of said inner layer, and
wherein said sheath member and said panel member are seamlessly integrated by brazing.
